(19) United States
(12) Patent Application Publication
(10) Pub. No.: US 2026/0068829 A1
(43) Pub. Date: Mar. 12, 2026

(54) MODULAR SELF-WATERING PLANTER SYSTEM

(71) Applicant: Brandon Nathan Tyler Lambdin, Garner, NC (US)

(72) Inventor: Brandon Nathan Tyler Lambdin, Garner, NC (US)

(21) Appl. No.: 19/325,686

(22) Filed: Sep. 11, 2025

Related U.S. Application Data
(60) Provisional application No. 63/693,302, filed on Sep. 11, 2024.

(51) Int. Cl. A01G 27/00; A01G 31/00

(52) U.S. Cl. CPC A01G 27/006; A01G 27/001; A01G 27/008; A01G 31/00

(57) ABSTRACT

The invention is a vertically stacked flood-and-drain growing system in which chambers are arranged in sequence to ensure complete root saturation throughout the vertical tower. Water from an upper reservoir enters the top chamber and flows downward via siphons that control flooding and draining from one chamber to the next. Each siphon is configured with a larger upflow opening and a smaller outflow opening to regulate water movement, and the siphon apex includes an opening with a removable plug to permit cleaning and maintenance. By filling only the top reservoir, water is distributed successively through all chambers, thereby delivering thorough and uniform hydration to plant roots while maintaining proper aeration.

### CROSS-REFERENCE TO RELATED APPLICATIONS

This application claims priority to U.S. Provisional Patent Application No. 63/693,302, filed Sep. 11, 2024, the entire content of which is incorporated by reference herein.

### FIELD OF THE INVENTION

The presently disclosed subject matter relates to an improved modular self-watering planter system that accommodates a wide variety of climbing and non-climbing plants. The presently disclosed subject matter also includes methods of making and using the modular planter system.

### BACKGROUND OF THE INVENTION

When growing indoor climbing plants, it is necessary that the plant have a source of water and nutrient supply, as well as an upright support around which to grow. Customarily, a moss pole is used to provide the required support and water supply. A moss pole is a cylindrical length of sturdy material wrapped in coco coir or moss, often surrounded by mesh. The pole is staked vertically into the soil of a potted plant, providing support for the climbing plant as it grows upward. As the plant grows, the plant roots pass into the mesh holes for support. However, conventional moss poles suffer from several drawbacks. For example, to mimic a humid environment, the moss must be kept moist at all times, which can be difficult to maintain. In addition, moss poles are limited to a predetermined height and once the plant outgrows the pole, the upper portion of the plant is unsupported, or the pole must be replaced with a larger moss pole. Further, moss poles can be easily overwatered, causing root rot or other harmful effects to the growing plants. In addition, moss poles have a limited lifespan and disintegrate after continued use, likely due to the moist conditions. It would therefore be beneficial to provide an improved plant self-watering and support system that overcomes the shortcomings of the prior art.

### SUMMARY OF THE INVENTION

In some embodiments, the presently disclosed subject matter is directed to a plant watering system. Specifically, the system comprises an upper reservoir defined by a bottom face comprising an opening and an opposed upper face, one or more sidewalls that join with the bottom face and the upper face to form an interior. The system includes one or more siphon chambers comprising a bottom face and an opposed top face, a series of sidewalls that create a chamber interior. Each siphon chamber also includes a siphon passageway that includes a siphon apex, a first end in fluid communication with the chamber interior, and a passageway second end that acts as a chamber exit. The interior of the siphon chamber is in fluid communication with the upper reservoir bottom opening. The first end has a diameter that is larger than a diameter of the second end. The siphon chamber includes one or more openings that have access to the chamber interior. The system also includes a container for housing a plant.

The term “container” includes any vessel, receptacle, or enclosure configured to hold and support a plant during growth. A container may be shaped and dimensioned to house a volume of soil, growing media, and/or a root system, and may include one or more openings, drainage features, or attachment points. A container may be constructed from a variety of materials, including (but not limited to) plastic, ceramic, clay, glass, wood, metal, or composite materials, and may be rigid, semi-rigid, or flexible. Containers may be permanent or removable components of the system, and may be positioned within or adjacent to a reservoir.

In some embodiments, the system includes two or more flood and drain siphon chambers in a vertical stacked arrangement. As used herein, “vertical stacked arrangement” refers to a configuration in which two or more components are positioned one above another along a substantially vertical axis. The term encompasses arrangements where the components are in direct contact (e.g., stacked chambers coupled end-to-end) or are indirectly supported in aligned tiers (e.g., separated by connectors, spacers, or fasteners) such that the overall orientation is upright. A vertical stacked arrangement may be linear and collinear (components aligned directly over each other), or may include minor offsets or alignment features provided that the components are arranged in a generally vertical column. In some embodiments, two or more siphon chambers are arranged in a vertical stacked arrangement, allowing water to flow downward from an upper chamber to a lower chamber in sequence. The modular orientation permits the overall system height to be increased or decreased as needed to support plant growth.

In some embodiments, each siphon chamber includes a plurality of openings.

In some embodiments, the interior of each siphon chamber comprises a growing media.

In some embodiments, the growing media is selected from lightweight expanded clay aggregate (LECA), lava stone, peat moss, coco coir, rice hulls, vermiculite, perlite, bark, sphagnum moss, minerals, synthetic grow media, rock wool, or combinations thereof.

In some embodiments, the siphon chamber passageway is configured to initiate a siphon action when the water level within the chamber interior rises above the apex of the passageway. As used herein, “siphon action” refers to the movement of a liquid from a higher elevation to a lower elevation through a conduit or passageway having an intermediate apex. The action is initiated once the liquid level in the higher reservoir rises above the apex of the conduit, thereby creating a continuous column of liquid. Under the influence of gravity, liquid is pulled over the apex and discharged into a lower region until the liquid level in the higher reservoir falls below the conduit inlet, at which point the flow ceases. Siphon action exploits the gravitational potential energy of the elevated liquid column and the cohesive forces within the liquid to maintain flow over the apex without the use of a pump.

In some embodiments, the siphon passageway is configured with an inverted U shape. As used herein, “inverted U-shape” (with reference to a conduit or passageway such as element 70) can refer to a shape or path having two legs joined by an upper apex, such that the apex is positioned above the leg ends when the shape is viewed in the relevant cross-sectional plane. The legs may be straight or curved, parallel or non-parallel, and the apex may be rounded, arched, or flat (cornered). The term includes arched, horseshoe-like, and omega-like profiles formed by continuous curvature and/or polygonal segments.

In some embodiments, the siphon passageway includes an opening positioned at a top surface, the opening configured to be opened and closed.

In some embodiments, the opening is closed with a removable plug.

In some embodiments, the system is hydroponic. As used herein, “hydroponic” refers to the cultivation of plants in the absence of soil as a nutrient source, wherein the plant roots receive water, oxygen, and dissolved nutrients from an aqueous solution. Hydroponic cultivation can include an inert or substantially inert support medium (e.g., LECA, perlite, vermiculite, coco coir, rock wool, lava stone) that does not itself provide substantial nutritive value, but serves to support the plant roots, retain moisture, and/or facilitate aeration. In hydroponic systems, soil (e.g., natural topsoil containing mineral and organic fractions that provide nutrients through biological/mineralogical processes) is excluded.

In some embodiments, the interior of the lower reservoir comprises a collection bottle.

In some embodiments, the transition between the first internal diameter and the second internal diameter occurs at or proximate to the siphon apex. The phrase “at or proximate to” refers to a spatial relationship in which a first element, feature, or point is located directly at, adjacent to, or near a second element, feature, or point. The phrase is intended to encompass positions of exact coincidence (i.e., “at”) as well as positions that are close enough to achieve the intended functional or structural relationship (i.e., “proximate to”). Unless otherwise specified, “proximate to” may include direct contact or a separation distance that is relatively small compared to the overall dimensions of the system, and that does not materially alter the intended operation. In some embodiments, “proximate to” may refer to distances within about 0-20% of a characteristic dimension of the referenced feature (e.g., diameter, length, or height), although larger or smaller tolerances may be acceptable depending on context. For example, in the siphon passageway, the transition between a first internal diameter and a second internal diameter may occur at or proximate to the siphon apex, meaning the transition may occur exactly at the apex or in a region immediately adjacent the apex sufficient to achieve the desired siphon-breaking functionality.

In some embodiments, each siphon chamber is configured to completely flood and subsequently drain before a lower siphon chamber begins to flood, thereby providing sequential flood-and-drain operation from an uppermost chamber to a lowermost chamber. As used herein, “completely flood” refers to a condition in which the interior volume of a chamber, conduit, or container is substantially filled with liquid such that the liquid level rises to or above the highest intended fluid fill line of that volume. In the context of a siphon chamber, “completely flood” can refer to a condition where the plant roots and any growing media within the chamber interior are fully submerged in liquid before the siphon action initiates drainage. Thus, the chamber interior can be filled to 100% of its designed liquid capacity or to a level sufficient to initiate siphon action and ensure that all root-contact surfaces and growing media are wetted, even if minor air pockets or voids remain.

As used herein, “flood and drain operation” refers to a cyclical process in which a chamber, container, or growing region is periodically filled (flooded) with liquid until the contents (e.g., plant roots and growing media) are substantially submerged, and is then emptied (drained) of liquid such that the contents are re-exposed to air. The flood phase provides hydration and nutrient delivery by saturating the root zone, while the drain phase restores aeration and prevents oversaturation. The alternating cycle mimics natural wet-dry root conditions and promotes both oxygenation and hydration of the plant. In the disclosed system, flood and drain operation occurs when water enters a siphon chamber until the chamber is completely flooded, after which siphon action initiates drainage into a lower chamber. Each chamber is configured to flood and then drain sequentially from the uppermost chamber to the lowermost chamber, creating a controlled cascade watering cycle.

In some embodiments, the presently disclosed subject matter is directed to a method of growing and supporting a plant. Specifically, the method comprises adding a volume of water to interior of the upper reservoir of the disclosed watering system. The method includes adding a plant to the container of the lower reservoir. The volume of water travels from the upper reservoir to the interior of the one or more siphon chambers to provide moisture to roots of the plant that contact the chamber openings. The volume of water travels from the one or more siphon chambers to the lower reservoir where it is collected and rerouted to the interior of the upper reservoir a desired number of times. The plant roots are provided with moisture as the water travels through the siphon chambers. The plant is exposed to a humid environment and the plant roots are supported.

As used herein, the phrase “plant roots are supported” refers to a condition in which the roots of a plant are physically stabilized, anchored, or maintained in position by contact with a surrounding medium, structure, or surface. Support can be provided by growing media (e.g., bark, perlite, LECA, sphagnum moss) and/or by structural components of the system (e.g., siphon chamber walls, openings, or containers). The support allows the roots to remain securely positioned while the plant grows vertically or laterally, prevents undue displacement during watering cycles, and promotes effective uptake of water, oxygen, and nutrients. For example, the plant roots are supported when they penetrate into siphon chamber openings and engage the interior growing media, thereby anchoring the plant to the modular column while still being exposed to moisture and aeration.

As used herein, “humid environment” refers to an atmospheric condition surrounding a plant or plant-support structure in which the relative humidity is elevated above ambient room humidity. A humid environment provides increased moisture content in the surrounding air, reducing water loss from plant tissues and mimicking the natural conditions of many tropical or climbing plant species. Thus, a humid environment can include relative humidity levels of at least about 50%, in some embodiments at least about 60%-80%, and in some embodiments greater than 90%, localized humidity generated by evaporation or slow release of water from growing media, chambers, or reservoirs, and environments that maintain air moisture in close proximity to plant roots, stems, or aerial tissues. In the disclosed system, a humid environment is produced as water flows through and evaporates from the siphon chambers and growing media, thereby surrounding the plant roots and aerial structures with consistently moist air without oversaturating the soil.

In some embodiments, the plant is a hemiepiphyte. In some embodiments, the hemiepiphyte is selected from a monstera, pothos, and/or pilodendron.

In some embodiments, the plant is a climbing plant. As used herein, “climbing plant” refers to any plant species that exhibits a growth habit of ascending or spreading upward by attaching to, leaning upon, or twining around a support structure rather than remaining self-supporting in an upright form. Climbing plants can include specialized morphological features to aid in vertical growth, including (but not limited to) aerial roots, tendrils, twining stems, adventitious roots, and/or adhesive pads. In the disclosed system, climbing plants can be supported by the vertical stacked arrangement of siphon chambers, which allow roots and stems to attach and grow upward while receiving sustained hydration and humidity. However, it should be understood that the disclosed system can be used with non-climbing plants as well as climbing plants. “Non-climbing plant” refers to a plant that grows in a generally upright, trailing, or spreading habit without specialized specialized structures (e.g., aerial roots, tendrils, or twining stems) for vertical attachment to a support.

In some embodiments, the method includes adding one or more additional siphon chambers vertically to the system as the plant grows.

### BRIEF DESCRIPTION OF THE DRAWINGS

FIG. 1 is a front view of a prior art moss pole in one embodiment.

FIG. 2 is a front plan view of a watering system in accordance with some embodiments of the presently disclosed subject matter.

FIG. 3a is a front plan view of a watering system upper reservoir in accordance with some embodiments of the presently disclosed subject matter.

FIG. 3b is a perspective view of a watering system upper reservoir in accordance with some embodiments of the presently disclosed subject matter.

FIG. 3c is a perspective view of an upper reservoir comprising a refill aperture in accordance with some embodiments of the presently disclosed subject matter.

FIG. 3d is a perspective view of an upper reservoir comprising a lid in accordance with some embodiments of the presently disclosed subject matter.

FIGS. 4a and 4b are front plan views of attaching an upper reservoir to one or more siphon chambers in accordance with some embodiments of the presently disclosed subject matter.

FIG. 5a is a side plan view of a watering system siphon chamber in accordance with some embodiments of the presently disclosed subject matter.

FIG. 5b is a cross-sectional view of a watering system siphon chamber in accordance with some embodiments of the presently disclosed subject matter.

FIG. 5c is a side cross-sectional view of a siphon chamber comprising growing media in accordance with some embodiments of the presently disclosed subject matter.

FIG. 5d is a fragmentary side cross-sectional view of a siphon passageway in accordance with some embodiments of the presently disclosed subject matter.

FIGS. 6a and 6b are cross-sectional views of siphon passageway diameters in accordance with some embodiments of the presently disclosed subject matter.

FIGS. 7a and 7b are cross-sectional side views of siphon chambers comprising a vertical overflow tube and passageway cleaning opening in accordance with some embodiments of the presently disclosed subject matter.

FIG. 8a is a front plan view of a lower reservoir in accordance with some embodiments of the presently disclosed subject matter.

FIG. 8b is a front plan view of a lower reservoir and attached siphoning chambers in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

The presently disclosed subject matter is directed to an improved growing and self-watering system for climbing plants and non-climbing plants, such as hemiepiphytes. The term “hemiepiphyte” refers to a plant or plant-like organism that spends part of its life cycle as an epiphyte. The term “epiphyte” refers to a plant or plant-like organism that grows on the surface of another plant and derives its moisture and nutrients from the air, rain, water (in marine environments), or from debris accumulating around it. As described in detail below, the disclosed system routes water from an upper reservoir through a series of siphon chambers, consistently providing moisture to the plant roots. Beneficially, the roots of the plant are exposed to oxygen in a highly humid environment that mimics the natural plant surroundings, allowing for optimal growing. The water is collected in a lower reservoir and continually routed back to the upper reservoir to repeat the watering cycle.

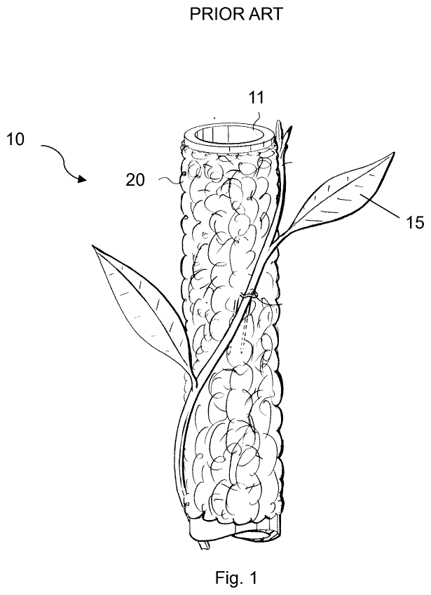

As noted above, climbing plants are conventionally grown using a moss pole. FIG. 1 illustrates a traditional moss pole arrangement. As shown, moss pole 10 provides support for a growing plant, such as a hemiepiphyte 15. The pole comprises an interior vertical support 11 that is typically wrapped with moss 20. The moss pole also includes a surrounding outer trellis that allows the plant to climb upwards, while anchoring the roots into the moss to gain support and absorb water and other nutrients. However, traditional moss poles must be constantly watered, which acts as a deterrent for many users. Further, it is very common for traditional moss poles to be overwatered, resulting in plant root rot that prevents the plant roots from getting oxygen and allowing harmful bacteria to thrive.

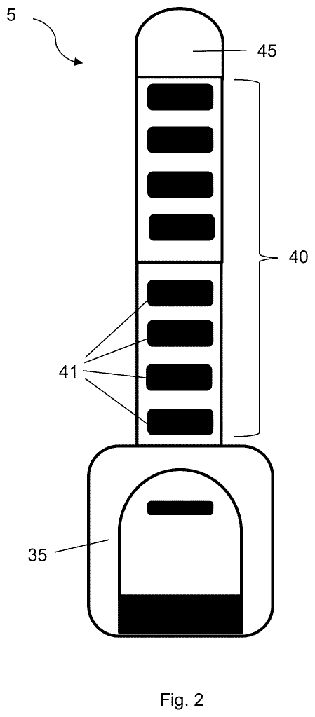

FIG. 2 illustrates one embodiment of the disclosed modular growing system 5 that overcomes the numerous shortcomings associated with conventional moss poles and related plant-support devices. As shown, the system includes lower reservoir 35, dimensioned to collect and store water that drains downward through the system. Unlike conventional support devices where excess water is lost or oversaturation of the plant's surrounding soil occurs, lower reservoir 35 recaptures water for reuse. Beneficially, the disclosed configuration not only prevents waste but also creates a stable base for supporting tall or heavy climbing plants, providing both hydration efficiency and structural reliability.

As used herein, “reservoir” refers to a container, chamber, and/or vessel configured to hold, store, or collect a volume of liquid (e.g., water or aqueous nutrient solution) for use in hydrating plants. A reservoir may be positioned above, below, or adjacent to one or more growing chambers and may serve as a source, collection point, or redistribution point for liquid within the system. A reservoir may be constructed from plastic, glass, ceramic, metal, or composite materials and may include inlets, outlets, openings, lids, valves, or flow-control structures. The term encompasses both upper reservoirs (e.g., liquid supply chambers feeding siphon chambers) and lower reservoirs (e.g., collection chambers receiving liquid drained through siphon chambers).

Extending vertically from the lower reservoir is a series of siphoning chambers 40, arranged in a stacked, modular fashion. Each chamber is configured to hold a volume of growing media while incorporating one or more access holes 41. The access holes enable plant roots to grow laterally into the chamber interiors, providing direct access to water and nutrients. In contrast to moss poles that rely on external misting and offer inconsistent contact with plant roots, the siphoning chambers establish a controlled, internalized environment where roots remain hydrated. Furthermore, the modularity of chambers 40 allows the user to increase or decrease the height of the system, replace individual chambers, and/or customize the growing medium used.

The system includes upper reservoir 45 positioned at the top of the vertical column, adapted to hold a supply of water. The upper reservoir includes a drainage outlet that directs water downward through siphoning chambers 40 and into lower reservoir 35. Unlike prior systems where water trickles irregularly across the exterior of a pole or evaporates rapidly, the disclosed system provides a deliberate, gravity-fed flow that ensures even distribution of moisture throughout the structure. In some embodiments, the upper reservoir can include valves or flow-control features to further regulate hydration rates, preventing root rot or oversaturation.

Once the water has passed through the system and accumulated in the lower reservoir, it can be recirculated back into the upper reservoir (e.g., manually or through the use of a pump). As a result, the system provides a closed-loop watering cycle, conserving water while maintaining consistent hydration of the plant root system. The ability to recycle water not only reduces maintenance but also ensures that any nutrients carried within the water remain available to the plant over multiple cycles.

Accordingly, the disclosed growing system offers significant advantages over conventional moss poles. Specifically, traditional moss poles serve only as static supports and require frequent manual watering, while the present system provides a dynamic, self-sustaining hydration mechanism that enables plant owners to leave their houseplants unattended for extended periods (e.g., days, weeks, or even months) without risk of underwatering or overwatering. By uniting the functions of plant support, modular growth, and closed-loop water management, the disclosed system delivers a level of reliability and convenience not previously achieved in the field of indoor plant care.

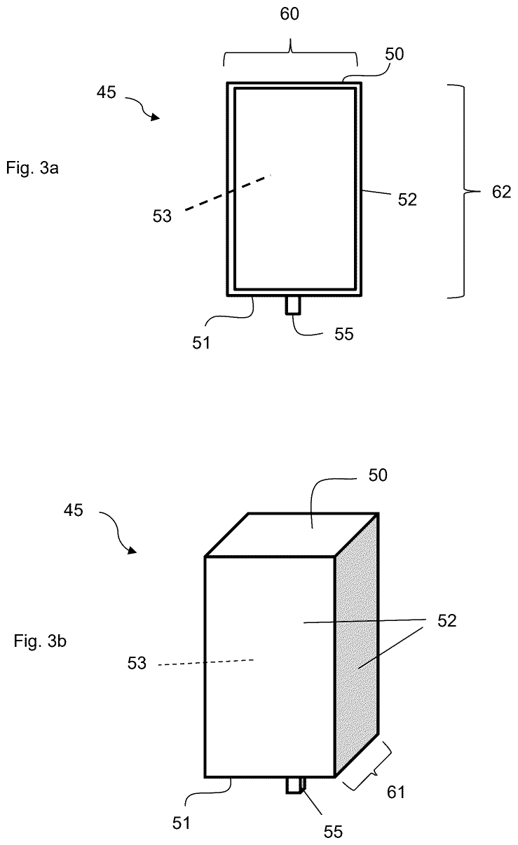

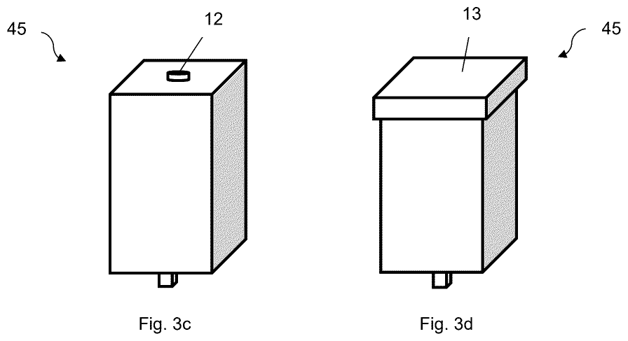

As noted above, the disclosed watering system includes an upper reservoir, a lower reservoir, and one or more siphon chambers. FIGS. 3a and 3b illustrate one embodiment of upper reservoir 45 of the disclosed watering system. The disclosed upper reservoir functions as a system funnel, directing water in a controlled and efficient manner into the vertical siphoning chambers, thereby ensuring consistent hydration while minimizing water loss.

As shown, the upper reservoir includes top face 50 and opposed bottom face 51, joined together by one or more sidewalls 52 to define an enclosed interior 53. Thus, the upper reservoir can be configured as a hollow container to hold a volume of water or other nutrient-rich fluid. The term “water” broadly includes tap water, distilled water, mineral water, or water supplemented with nutrients, fertilizers, or growth-promoting additives suitable for plant development. Unlike prior designs where water is stored only in the plant pot or external trays, upper reservoir 45 integrates storage directly into the vertical support, thereby combining structural and functional elements.

Bottom face 51 of the upper reservoir includes opening 55 that permits water to flow from the reservoir interior 53 into the first siphoning chamber positioned directly below. Opening 55 can be configured in any suitable manner, including (but not limited to) a hole, gap, slit, aperture, void, and/or passageway, and can be designed to regulate flow rate. In some embodiments, water flows via gravity, establishing a passive but continuous downward distribution without requiring external pumps or hoses. In contrast to conventional systems, where water often evaporates or bypasses plant roots, the gravity-fed outlet ensures that water enters directly into the root-accessible siphoning chambers.

The upper reservoir can also include features to facilitate refilling and maintenance. For example, the top face 50 can include refill aperture 12 or removable lid 13 to allow initial insertion and replenishment of water into the interior 53, as shown in FIGS. 3c and 3d. Advantageously, once closed, the top face shields the interior from dust, pests, or other contaminants that commonly degrade traditional moss poles or exposed watering containers. This improves hygiene, reduces microbial growth, and extends the lifespan of both the system and the plant.

It should be appreciated that the upper reservoir 45 is not limited to any single geometry. Specifically, the reservoir can assume any suitable cross-sectional shape, including (but not limited to) oval, circular, square, rectangular, triangular, pentagonal, hexagonal, or octagonal. Similarly, the upper reservoir can be constructed in a wide range of sizes. For example, the upper reservoir can have length 60, width 61, and/or height 62 ranging from at least about (or no more than about) 5 inches to about 100 inches, with intermediate values (e.g., at least/no more than about 10, 20, 30, 40, 50, 60, 70, 80, 90 inches) suitable for different plant varieties. The term “length” refers to the longest horizontal distance of the reservoir (e.g., between opposed sidewalls as shown in FIG. 3a), the term “width” refers to the longest horizontal distance perpendicular to the length (e.g., between the front and rear sidewalls), and the term “height” refers to the vertical distance between top face 50 and bottom face 51.

The capacity of the upper reservoir interior can vary depending on system requirements. In some embodiments, the reservoir can hold between about 1-10 about 10 gallons of water (or any suitable fluid). In some embodiments, the volume of the upper reservoir is substantially greater than the volume of each individual siphoning chamber 40. For instance, the upper reservoir can be at least about (or no more than about) 400% larger than a single chamber (e.g., at least/no more than about 200%, 300%, 400%, 500%, or more). Thus, if a siphoning chamber 40 has a volume of 0.5 gallons, the upper reservoir 45 can include an interior volume of at least about 2 gallons. The disproportionate sizing provides a buffering effect, ensuring that the system can continuously hydrate the plant for prolonged periods without frequent refilling, a feature not present in conventional supports.

Thus, upper reservoir 45 functions not only as a storage vessel, but also as a controlled fluid-distribution component. By integrating water storage, contamination protection, scalable sizing, and gravity-fed release into a single modular structure, the disclosed reservoir provides a substantial improvement over conventional moss poles and/or drip systems, enabling extended unattended plant care with consistent and reliable hydration.

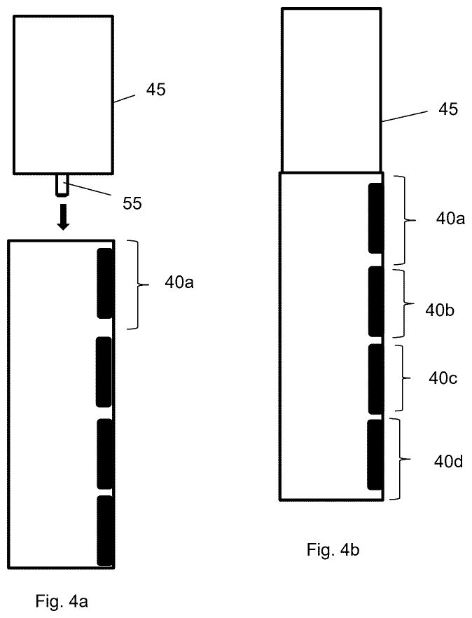

As shown in FIGS. 4a and 4b, opening 55 of upper reservoir 45 is disposed in fluid communication with the first siphon chamber 40a. As used herein, the term “first siphon chamber” refers to the siphon chamber positioned immediately adjacent to and in direct contact with the upper reservoir. In this configuration, water stored within the upper reservoir is able to flow directly and continuously into the first siphon chamber, thereby initiating the downward distribution of fluid throughout the vertical column of chambers.

In some embodiments, opening 55 can be integrated into, aligned with, and/or in physical contact with a top surface of first siphon chamber 40a. In this way, the system ensures that water exits upper reservoir 45 at a predictable location and enters the siphon chamber without leakage, bypass, or evaporation losses that are common in conventional plant support systems. The direct fluid pathway also eliminates the need for separate hoses, external funnels, and/or manual watering steps. Advantageously, the disclosed configuration establishes a seamless, gravity-fed connection between the reservoir and the upper chamber, allowing for consistent hydration of the plant root zone.

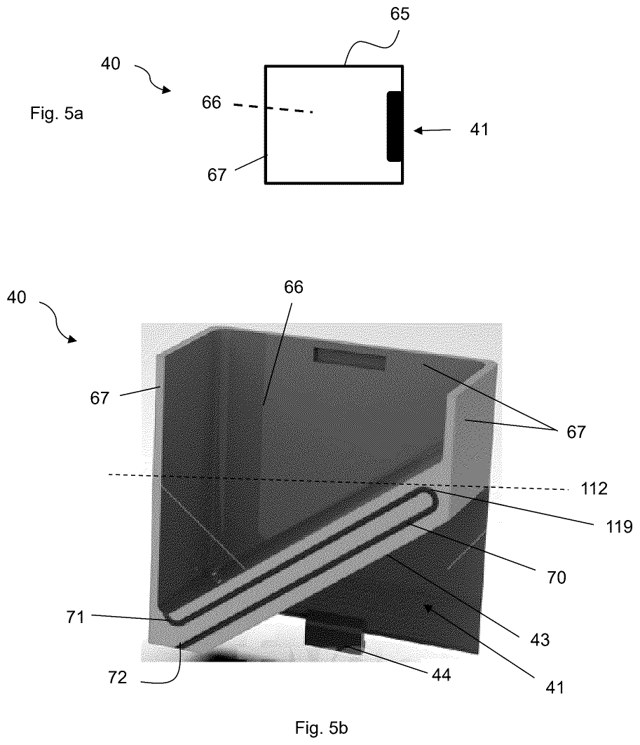

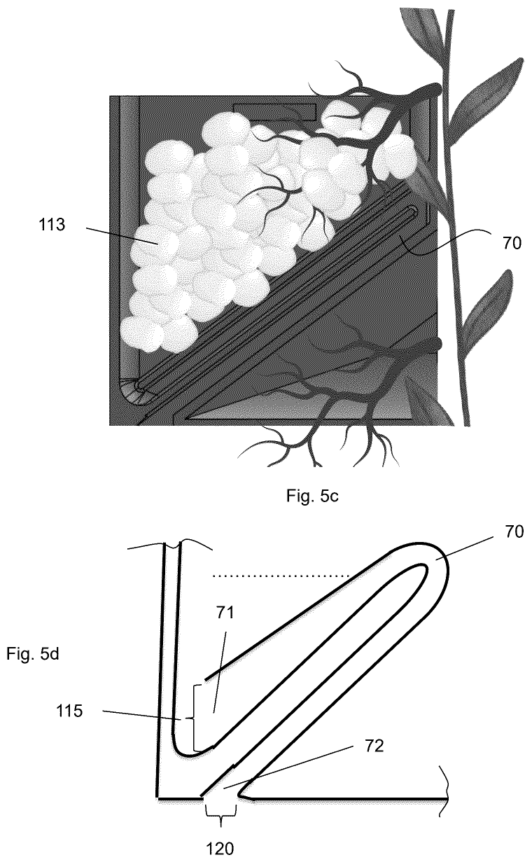

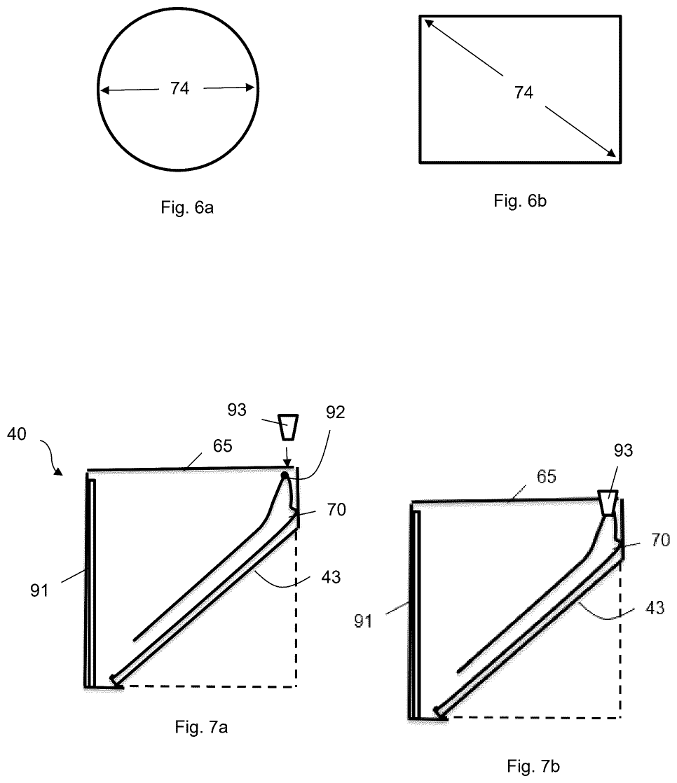

As noted above, water flows from upper reservoir 45, through opening 55, and into first siphon chamber 40a, thereafter cascading into successive siphon chambers positioned below. FIG. 5a illustrates one embodiment of an individual siphon chamber 40 that forms the core modular unit of the disclosed growing system. Each siphon chamber 40 includes an open top face 65 that establishes direct fluid communication with the chamber interior 66. As a result, water descending from the chamber positioned immediately above flows seamlessly into the interior of the underlying chamber, thereby creating a vertical chain of hydration.

Each siphon chamber 40 also includes one or more outer sidewalls 67 that are joined together to define and enclose interior 66. The interior cavity is adapted to house growing media, water, and/or plant roots, thereby functioning as both a root-holding compartment and a fluid distribution chamber.

Advantageously, the modular siphon chambers 40 allow multiple units to be stacked, removed, and/or replaced, enabling scalability to suit plants of varying sizes and growth rates. The modularity ensures that the system can be tailored to the needs of different plant species, while still maintaining the closed-loop hydration cycle initiated at the upper reservoir.

Each siphon chamber 40 further includes one or more openings 41 that provide direct access to chamber interior 66. The openings are strategically positioned so that the roots of a plant growing vertically along the exterior surface of the siphon chamber can extend inward through opening 41 to access the water and/or growing media housed within. As a result, root integration is promoted with the internal hydration cycle of the system.

Openings 41 can be formed in any suitable size, shape, and/or orientation. It should be appreciated that larger or smaller dimensions can also be used depending on plant species or system requirements. The openings can be circular, oval, rectangular, hexagonal, slotted, and/or irregular in shape, and can be positioned at varying heights along each chamber sidewall 67. In some embodiments, each siphon chamber includes at least one opening (e.g., 1, 2, 3, 4 or more openings), either evenly distributed or arranged asymmetrically around the chamber exterior to maximize root access and aeration.

As shown in FIG. 5b, each opening 41 is defined by angled wall 43. The angled wall provides a sloped transition from the exterior of the chamber to the interior cavity, thereby facilitating root entry and minimizing the likelihood of damage to delicate root tissue. In some embodiments, the angled wall can slope at an angle of about 20-75 degrees relative to the vertical axis of the chamber, such as at least/no more than about 20, 25, 30, 35, 40, 45, 50, 55, 60, 65, 70, or 75 degrees. The slope can be selected to encourage roots to penetrate inward while also directing water and nutrients toward the entry point, further enhancing hydration efficiency. The disclosed angled wall openings 41 create deliberate, repeatable, and functional access points for root integration. As a result, plant stability is improved, water and nutrient uptake is increased, and more resilient root systems are supported.

As illustrated in FIG. 5c, interior 66 of each siphon chamber 40 is adapted to house a predetermined volume of growing media 113. As used herein, the term “growing media” broadly refers to any particulate, porous, fibrous, and/or inert substrate material that supports cultivation of a plant. Growing media 113 can include (but is not limited to) lightweight expanded clay aggregate (LECA), lava stone, peat moss, coco coir, rice hulls, vermiculite, perlite, and/or combinations thereof. In some embodiments, mixtures of two or more media are employed to achieve a balance of water retention, drainage, and root aeration. For example, a blend of LECA and perlite can provide structural stability with increased drainage, while coco coir and vermiculite can enhance water retention and nutrient availability.

Lightweight Expanded Clay Aggregate (LECA) refers to clay that is dried and burned such that it is expanded into a lightweight aggregate. The heating process causes gases trapped in the clay to expand, forming thousands of small bubbles and giving the material a porous structure.

“Lava stone” is formed when volcanoes erupt and expelled magma cools and eventually dries. Lava stones are highly porous which deters the growth of fungus, algae, and bacteria.

The term “peat moss” refers to composted Sphagnum moss. Sphagnum moss and the peat formed from it do not decay readily because of the phenolic compounds embedded in the moss's cell walls. Accumulations of peat moss can store water, since both living and dead plants can hold large quantities of water inside their cells. In some embodiments “peat moss” can include sphagnum moss. As used herein, the term “sphagnum moss” refers to plant material derived from mosses of the genus Sphagnum. Sphagnum moss is characterized by its fibrous and porous structure, high absorbency, and natural acidity.

“Coco coir” (or “coconut coir”) refers to the natural fiber extracted from the outer husk of the coconut. Typically, coco coir includes brown fibers from mature and ripe coconuts and white fibers that are generated from pre-ripe coconuts. Coco coir is hydrophilic, absorbs water easily, and forms a gel-like substance when exposed to fluid. As a result, coco coir has enough moisture to keep plants hydrated without causing root rot and fungal development problems.

Vermiculite is a hydrous phyllosilicate mineral that undergoes significant expansion when heated. Vermiculite is a 2:1 clay.

Rice hulls are a byproduct of rice production. Further, rice hulls are hydrophilic, absorbing water easily during hydration. Rice hulls also have a high nutrient capacity, are compostable, and are natural.

Perlite is an amorphous volcanic glass, typically formed by the hydration of obsidian. It naturally occurs and greatly expands when heated.

The term “bark” refers to a woody plant by-product derived from the outer covering of trees, typically processed into chips, chunks, or shredded particles for use as a plant growth substrate. Bark used as a growing medium is generally porous and fibrous, providing aeration, drainage, and mechanical support to plant roots.

“Sphagnum moss” refers to the fibrous plant material harvested from living or dried mosses of the genus Sphagnum. Sphagnum moss is characterized by its lightweight, porous, and highly absorbent structure, enabling it to retain many times its weight in water while still providing aeration to plant roots. Unlike peat moss (which is the partially decomposed form of sphagnum accumulated over time in bogs), sphagnum moss retains a stringy, fibrous texture and is commonly used in horticulture as a rooting medium, soil amendment, or hydroponic substrate.

“Minerals” include naturally occurring inorganic substances that are processed or selected for use as a plant growth substrate. In the context of growing media, minerals are typically non-soil, substantially inert materials that provide structural support, porosity, drainage, and/or water-retention capacity but contribute little or no nutritive value on their own.

“Synthetic grow media” refers to engineered or manufactured substrates that are artificially produced rather than naturally occurring, and are designed to provide mechanical support, aeration, water retention, and/or nutrient delivery for plant roots. Synthetic grow media are typically inert or substantially inert, meaning they do not contribute significant nutritive value on their own, but act as a stable medium for hydroponic or semi-hydroponic growth. Examples include (but are not limited to) polymeric foams (e.g., polyurethane foam, phenolic foam cubes), ceramic beads, porous ceramic pellets, glass wool, fiberglass substrate fibers, synthetic fiber mats.

“Rock wool” refers to a synthetic growing medium formed by melting natural rock materials such as basalt, diabase, or dolomite, and then spinning the molten material into thin fibers. The fibers are collected and compressed into cubes, slabs, plugs, or loose fill. Rock wool is characterized by being lightweight, porous, and fibrous, with a high capacity to retain water and dissolved nutrients while simultaneously providing ample aeration for plant roots. It is chemically stable, substantially inert, and reusable when sterilized.

The volume of growing media 113 placed within the chamber interior 66 may vary. In some embodiments, the chamber is fully filled (e.g., about 100% of the interior volume), thereby maximizing root contact with the growing media. In other embodiments, the chamber can be partially filled (e.g., less than 100% of the volume, such as about 20%, 40%, 60%, or 80%) to allow for increased water storage capacity within the remaining space. By adjusting the percentage fill, users can tailor the hydration dynamics of the system to suit specific plant species or growth conditions.

When the system is in operation, water flows downward from upper reservoir 45, through the opening 55, and sequentially into the siphon chambers. As water contacts growing media 113, the media becomes saturated with both water and dissolved nutrients. The saturation provides plant roots entering through openings 41 with a consistent, evenly distributed supply of moisture and nutrients.

As illustrated in FIGS. 5b-5d, each siphon chamber 40 includes an interior siphon passageway 70 that facilitates the controlled transfer of water from upper reservoir 45 or upper siphon chamber into successive lower chambers, and ultimately into the bottommost reservoir. The siphon passageway 70 is in fluid communication with the chamber interior 66, thereby enabling water to cycle through the system without requiring an external pump. Specifically, each passageway includes first end 71 disposed in contact with the chamber interior 66 and opposed second end 72 that discharges into the interior of a lower chamber. It should be appreciated that the passageway may assume a wide variety of geometries, provided that it maintains the functional siphon effect described herein.

During operation, water from upper reservoir 45 exits via opening 55 and enters interior 66 of the first siphon chamber. Once the water level rises above the top of the siphon (illustrated by dotted line 112), a siphoning action is initiated. Specifically, water flows from the chamber interior 66 into the first end 71 of passageway 70, over the siphon apex 119, and downward to second end 72 of the passageway, where it is delivered into the chamber directly below. In this way, the water level within the passageway rises to equalize with the water level inside the chamber interior, thereby sustaining the siphon effect. As the water level fluctuates, growing media 113 and roots inside the chamber are alternately submerged and then re-exposed to oxygen and humidity, creating a highly favorable environment for plant growth.

As used herein, the term “siphon” refers to a conduit that exploits the weight of a liquid to transfer fluid from a higher level to a lower level. However, in conventional systems, siphons (especially those with small internal diameters) often retain undesirable residual fluid columns due to surface tension and capillary action. The residual fluid can obstruct subsequent siphon cycles, reduce efficiency, and create stagnation that fosters microbial growth. However, system 5 overcomes the noted limitations through a novel structural configuration of the siphon passageway 70. In some embodiments, the passageway can be formed as a single, continuous inverted U-shaped conduit having an inlet portion (uptake leg), a downflow portion (outlet leg), and an apex. In some embodiments, the passageway includes a differential internal diameter along the length of the passageway. For example, first end 71 can include first internal diameter 115, while the outlet portion (second end 72) can include second internal diameter 120, wherein first internal diameter is substantially larger than the second internal diameter, as shown in FIG. 5d.

As used herein, “siphon apex” refers to the uppermost point along the flow path of a siphon passageway, conduit, or lumen, located between an inlet leg and an outlet leg of the siphon. The siphon apex represents the highest elevation that liquid must reach to initiate siphon action. The siphon apex may be rounded, arched, or angular, and may include diameter transitions, ports, or service openings. In some embodiments, the siphon apex defines the fill level threshold at which liquid begins to flow over into the outlet leg, thereby initiating the flood-and-drain cycle. In the disclosed system, the siphon apex can be the point near which the transition between a first internal diameter and a second internal diameter occurs, ensuring that once liquid rises above the apex, siphon action commences and the chamber subsequently drains.

The larger first internal diameter 115 can be sufficiently wide such that the cohesive and adhesive forces of the fluid (i.e., surface tension and capillarity) are inadequate to sustain a column of liquid once the siphon is broken by the introduction of gas (e.g., air). In some embodiments, diameter 115 may range from about 5 mm to about 10 mm, such as at least/no more than about 5, 6, 7, 8, 9, or 10 mm. The smaller outlet diameter 72 can range from about 1 mm to about 4 mm, such as at least/no more than about 1, 2, 3, 4, 5, 6, 7, 8, 9, 10 mm. The transition between diameters 115 and 120 can occur smoothly at or near the apex of the siphon passageway. By employing the configuration of FIG. 5d, the siphon breaks cleanly when the water level falls below the inlet, and any remaining fluid volume within both the inlet and outlet portions is evacuated entirely by gravity.

The system can also include one or more optional features. For example, vertical overflow tube 91 may extend above the siphon top (element 112) within the chamber interior, thereby preventing overfilling by allowing excess water to bypass directly into the chamber below. In some embodiments, the overflow tube can be located adjacent to the top edge of chamber 40 (e.g., about 0.5 cm from the top edge), as shown in FIG. 7a. Additionally, siphon passageway 70 may include an entry port 92 located at or near the apex, which may be fitted with a removable plug 93. This feature allows a user to clean the siphon passageway and remove blockages as necessary, ensuring long-term functionality.

Accordingly, the disclosed siphon passageway provides a self-priming, self-clearing, and maintenance-friendly fluid transfer system. By employing an inverted U-shaped conduit with a larger-diameter inlet portion 115 and a smaller-diameter outlet portion 120, the passageway prevents retention of residual fluid, ensures consistent siphon cycling, and eliminates inefficiencies common in prior art siphon systems.

As used herein, “diameter” refers to a characteristic linear dimension across a cross-section of an element, conduit, passageway, or opening. For a circular cross-section, the diameter is the distance between two points on the boundary measured through the geometric center. For non-circular cross-sections (e.g., elliptical, oval, polygonal, or irregular shapes), the term “diameter” can encompass the maximum distance across the cross-section, the minimum distance across the cross-section, or an effective diameter, which can be defined in terms of an equivalent circle having the same cross-sectional area as the non-circular shape. Unless otherwise specified, the context determines whether diameter refers to maximum, minimum, or effective diameter. The term further encompasses both internal diameters (measured between opposing inner wall surfaces of a passageway or lumen) and external diameters (measured between opposing outer wall surfaces of a body).

In some embodiments, each siphon chamber 40 is configured to be releasably attachable to an upper and/or lower chamber, thereby allowing the overall modular growing system 5 to be customized and scaled according to user preference. For example, a first chamber 40a may be positioned directly above a second chamber 40b, with additional chambers 40c and 40d (and additional optional chambers) added sequentially to extend the height of the system.

Any suitable fastener 44 can be used to join and detach adjacent chambers in a secure yet releasable manner. Representative fasteners include (but are not limited to) clips, latches, threaded couplings, detents, friction-fit connections, and/or magnets. In some embodiments, the fasteners can provide a tool-free attachment mechanism, enabling quick reconfiguration of the system without specialized equipment. In some embodiments, the fasteners may include alignment features (e.g., grooves, ridges, or keyed connectors) to ensure that the chambers are properly oriented and securely stacked. When connected, multiple siphon chambers 40 can be joined together to create an extended vertical region of increased length. The chambers may be aligned in parallel vertical orientation (e.g., one chamber directly stacked on top of another), thereby forming a structurally stable column capable of supporting climbing plants.

The siphon chambers 40 can be manufactured in a range of dimensions to suit different plants and environments. For example, each chamber can have a length, width, and/or height ranging from about 5 inches to about 100 inches, such as at least/no more than about 5, 10, 15, 20, 25, 30, 35, 40, 45, 50, 55, 60, 65, 70, 75, 80, 85, 90, 95, or 100 inches. In addition to external dimensions, the internal volume of each chamber can vary depending on the desired capacity for growing media and water. In some embodiments, a chamber interior can hold between about 0.25 gallons and about 2 gallons of material, such as at least/no more than about 0.25, 0.5, 0.75, 1.0, 1.25, 1.5, 1.75, or 2.0 gallons. Larger or smaller volumes may also be implemented in alternative designs, depending on plant species and system size.

System 5 can include any number of siphon chambers 40 depending on user needs. For example, the system can include 1-10 siphon chambers (e.g., at least/no more than about 1, 2, 3, 4, 5, 6, 7, 8, 9, or 10 chambers). In some embodiments, the system may include more than 10 chambers, thereby permitting very tall or large-scale plant support structures suitable for long-term plant growth. Advantageously, the modular configuration provides scalability, flexibility, and ease of use. Users can begin with a single siphon chamber and later expand the system by adding additional chambers as the plant grows. Conversely, chambers may be removed to downsize the system or to facilitate cleaning and maintenance. By allowing chambers 40 to be releasably joined and vertically stacked, the disclosed design offers significant improvements over prior art supports that lack modularity and often require complete replacement when resizing is desired.

In use, system 5 can be used to grow and support a climbing plant, such as a climbing hemiepiphyte. Suitable hemiepiphytes can include (but are not limited to) Monstera, Pothos, and/or Philodendron.

The term “monstera” refers to a genus of 59 species of flowering plants in the arum family, Araceae, native to tropical regions of the Americas. Plants are considered herbs or evergreen vines, growing to heights of 20 meters (66 ft) in trees. The plants climb by means of aerial roots that act as hooks over branches. The roots will also grow into the soil to help support the plant. The leaves are alternate, leathery, dark green, very large, from 25-90 centimeters (9.8-35.4 in) long (up to 300 centimeters (120 in) long in M. gigas) and 15-75 centimeters (5.9-29.5 in) broad, often with holes in the leaf blade. The fenestrated leaves allow for the leaves to spread over greater area to increase sunlight exposure and to allow light to reach other leaves below by using less energy to produce and maintain the leaves.

“Pothos” includes a genus of flowering plants in the family Araceae (tribe Potheae), native to China, the Indian Subcontinent, Australia, New Guinea, Southeast Asia, and various islands of the Pacific and Indian Oceans. Pothos plants are commonly grown as houseplants because they are easy to care for, thrive and grow quickly without excessive care. Pothos plants are known for their heart shaped leaves and fast growing vines.

The term “philodendron” refers to a large genus of flowering plants in the family Araceae. The leaves are usually large and imposing, often lobed or deeply cut, and may be more or less pinnate. Philodendrons also produce cataphylls, which are modified leaves that surround and protect the newly forming leaves. Cataphylls are usually green, leaf-like, and rigid while they are protecting the leaf. Philodendrons have both aerial and subterranean roots. The aerial roots occur in many shapes and sizes and originate from most of the plant's nodes or occasionally from an internode. The size and number of aerial roots per node depends on the presence of a suitable substrate for the roots to attach themselves. Aerial roots serve two primary purposes. They allow the philodendron to attach itself to a tree or other plant, and they allow it to collect water and nutrients.

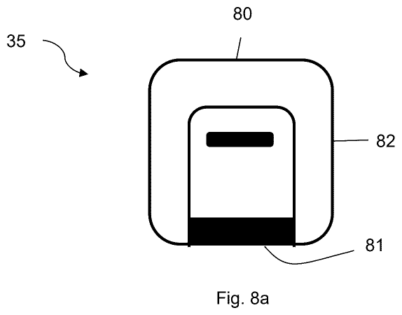

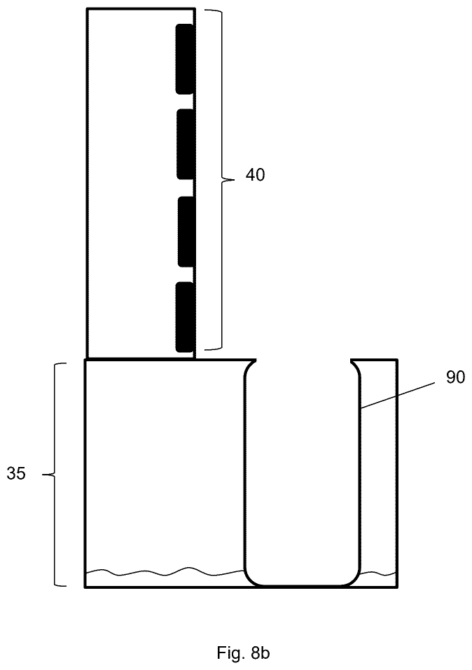

As noted above, the system includes lower reservoir 35 that houses a volume of water as it flows from the top reservoir through the siphon chambers. Thus, water that enters the system collects in lower reservoir 35 and can re-enter the system by being manually poured or automatically routed (e.g., via a pump) back to the upper reservoir. One embodiment of the lower reservoir is illustrated in FIG. 8a. As shown, the lower reservoir includes open top 80 and opposed bottom face 81. The lower reservoir also includes one or more sidewalls 82 that join with the bottom to create interior 83 that houses a volume of collected liquid.

The lower reservoir interior can house any volume of fluid (e.g., at least/no more than about 1, 2, 3, 4, 5, 6, 7, 8, 9, 10 gallons).

As shown in FIG. 8b, the lower reservoir can include inner container 90 for housing a plant, such as a climbing hemiepiphyte. The container can be shaped and configured as a pot with a lower surface in contact with collected water on the bottom of the interior of the reservoir. In this way, the plant can remain hydrated through capillary action.

In some embodiments, the plant is deposited into a container to provide any needed soil. As the plant grows, one or more siphon chambers 40 can be horizontally stacked onto the top surface of the lower reservoir, along with top reservoir 45. However, additional of the stacked chambers is optional. To this end, all but one siphon chamber may be removed to provide a self-watering planter that operates as described above, but for plants that do not need the climbing surface.

As noted above, each chamber includes one or more openings that allow the plant to vertically climb upwards. Thus, the opening allow roots of the climbing plant to engage the growing media 113 housed within siphon chamber interior 66. The openings therefore support the plant as it grows and allow the roots to contact water as it flows through the interior of each siphon chamber. Further, the chamber openings promote slow and continuous release of moisture from the moist chamber interior into the atmosphere surrounding the plant, providing a humid environment.

As needed, a user can deposit water from the lower reservoir to the interior of the upper reservoir. Water then flows down to the one or more siphon chambers and slowly accumulates in the lower reservoir. Thus, water quickly and frequently flows through the siphon chambers, leaving the plant roots exposed to the surrounding environment (e.g., oxygen) the remainder of the time. Because of the frequent flowing action of the water as it travels from the upper reservoir, through the chambers and to the lower reservoir, the environment is humid. Advantageously, a natural humid environment is created to promote the health of the plant. Thus, system 5 is configured to completely flood each chamber 40, submerging the plant roots and the growing media. All of the water is then drained to the lower reservoir where it can be pumped or manually deposited into the upper reservoir.

As the plant grows, additional siphon chambers can be successively stacked to accommodate a taller plant. Any number of siphon chambers 40 can be added. In this way, system 5 is modular, allowing a user to add or remove siphon chambers as needed during the plant life cycle.

System 5 offers many advantages over prior art watering systems. For example, the disclosed system is self-watering and requires no human intervention in some embodiments. Accordingly, the proper amount of watering is achieved to promote optimal plant health.

The disclosed system is modular, allowing successive siphon chambers to be added or removed as the plant grows or changes. Thus, a user can add or remove vertical siphon chambers 40 as desired.

System 5 prevents overwatering, thereby eliminating root rot and other negative consequences that result when plants receive too much water.

System 5 is easy to use, such that even children or the elderly can successfully use and enjoy the watering system.

The disclosed system is easy to assemble during use. The system is also easily and quickly disassembled if desired by a user.

The disclosed watering system is reusable. For example, if a plant unexpectedly dies or is repotted, the system can be reused with a new plant.

System 5 is also aesthetically pleasing, providing an attractive item for display at a user's home or business.

Additionally, the system can be customized by users, such as the use of a growing medium of choice. In this way, the user can select the proper growing media for a particular plant, leading to faster growth and increased plant health.

The disclosed system can be configured as a hydroponic system by selection of non-soil growth medium. Hydroponic growing systems use only water to grow plants. With this type of system, issues that are related to growing plants are not present.

System 5 has a wide variety of applications, from home use to vertical farming or commercial use. For example, system 5 can form a component of an ornament vertical green wall popular in lobbies and on building exteriors.

Further, young plants look nothing like mature plants. Everyone wants a big mature Monstera or Philodendron. It can often take years to get the big leaves with fenestrations. As a plant matures, growers have to take the top of their moss pole, chop it from the bottom half, re-pot it again, and add a new pole to the top for the plant to continue growing up and maturing in looks. The disclosed system makes it much easier to remove the top section, add it to the reservoir base, empty the younger sections that were on the bottom, and add those sections to the top, ready for new growth. The removed younger plant sections can easily be divided and shared or sold. Often grown in moss, it's a headache to split these plants. As these plant sections are rooted in individual cells, it's much easier to divide the vines. Vines can be divided at each leaf node.

System 5 can be used to irrigate house plants automatically and reliably.

Further, all but one siphon chamber may be removed to provide a self-watering planter that operates as set forth above, but for plants that do not need the climbing surface. Accordingly, system 5 is versatile and can be used with a variety of climbing and non-climbing plants.

In the growing and maintenance of small plants and agricultural plantings there is a need to provide water or an applicable nourishing liquid to the root system of a plant in a controlled manner, on a substantially continuous basis, and in correct amounts. This allows the particular plant to feed itself as needed, without the damaging effects of overwatering. Unless the context dictates otherwise, “water” (as used herein) refers to an aqueous solution, including, but not limited to, a mineral and/or nutrient-rich aqueous solution used to support plant growth and health.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A plant watering system comprising:
an upper reservoir defined by a bottom face comprising an upper reservoir opening and an opposed upper face, one or more sidewalls that join with the bottom face and the upper face to form an interior;
one or more siphon chambers comprising:
a bottom face and an opposed top face, a series of sidewalls that create a chamber interior;
a siphon passageway that includes a siphon apex, a first end in fluid communication with the chamber interior, and a passageway second end that acts as a chamber exit, wherein the interior of the siphon chamber is in fluid communication with the upper reservoir opening, wherein the first end has a diameter that is larger than a diameter of the second end; and
one or more siphon chamber openings that have access to the chamber interior; and
a container for housing a plant.

2. The system of claim 1, comprising two or more flood and drain siphon chambers in a vertical stacked arrangement.

3. The system of claim 1, wherein each siphon chamber includes a plurality of siphon chamber openings.

4. The system of claim 1, wherein the interior of each siphon chamber comprises a growing media.

5. The system of claim 4, wherein the growing media is selected from lightweight expanded clay aggregate (LECA), lava stone, peat moss, coco coir, rice hulls, vermiculite, perlite, bark, sphagnum moss, minerals, synthetic grow media, rock wool, or combinations thereof.

6. The system of claim 1, wherein the siphon chamber passageway is configured to initiate a siphon action when a water level within the chamber interior rises above the siphon apex of the passageway.

7. The system of claim 1, wherein the siphon passageway is configured with an inverted U shape.

8. The system of claim 1, wherein the siphon passageway includes an opening positioned at a top surface, the opening configured to be opened and closed.

9. The system of claim 8, wherein the opening is closed with a removable plug.

10. The system of claim 1, wherein the system is hydroponic.

11. The system of claim 1, wherein the interior of the lower reservoir comprises a collection bottle.

12. The system of claim 1, wherein the transition between the first internal diameter and the second internal diameter occurs at or proximate to the siphon apex.

13. The system of claim 1, wherein each siphon chamber is configured to completely flood and subsequently drain before a lower siphon chamber begins to flood, thereby providing sequential flood-and-drain operation from an uppermost chamber to a lowermost chamber.

14. A method of growing and supporting a plant, the method comprising:
adding a volume of water to interior of the upper reservoir of the watering system of claim 1;
adding a plant to the container of the lower reservoir;
wherein the volume of water travels from the upper reservoir to the interior of the one or more siphon chambers to provide moisture to roots of the plant that contact the chamber openings;
wherein the volume of water travels from the one or more siphon chambers to the lower reservoir where it is collected and rerouted to the interior of the upper reservoir a desired number of times;
wherein the plant roots are provided with moisture as the water travels through the siphon chambers; and
wherein the plant is exposed to a humid environment; and
wherein the plant roots are supported.

15. The method of claim 14, wherein the plant is a hemiepiphyte.

16. The method of claim 15, wherein the hemiepiphyte is selected from a monstera, pothos, pilodendron, or combinations thereof.

17. The method of claim 14, wherein the plant is a climbing plant.

18. The method of claim 14, further comprising adding one or more additional siphon chambers vertically to the system as the plant grows.
